(19) United States
(12) Patent Application Publication
(10) Pub. No.: US 2008/0306226 A1
(43) Pub. Date: Dec. 11, 2008

(54) Polymerization Catalyst System Based on Monooxime Ligands

(75) Inventors: Loise Boulanger, Vandoeuvre Les Nancy (FR); Olivier Lavastre, Gahard (FR); Sabine Sirol, Wauthier-Braine (BE); Abbas Razavi, Mons (BE)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/996,135

(22) PCT Filed: Jul. 17, 2006
(86) PCT No.: PCT/EP06/64334

§ 371 Date: Jul. 14, 2008

(30) Foreign Application Priority Data
Jul. 19, 2005 (EP) 05291548.5

(51) Int. Cl. C08F 4/42; B01J 31/18; B01J 31/14; C08F 4/52

(52) U.S. Cl. 526/90; 502/167; 502/103

(57) ABSTRACT

The present invention discloses active oligomerisation and polymerisation catalyst systems based on monooxime ligands.

This invention relates to the field of monooxime ligands and their use in catalyst system for the polymerisation of ethylene and alpha-olefins.

There exists a multitude of catalyst systems available for polymerising or oligomerising ethylene and alpha-olefins, but there is a growing need for finding new systems capable to tailor polymers with very specific properties. More and more post-metallocene catalyst components based on early or late transition metals from Groups 3 to 10 of the Periodic Table have recently been investigated such as for example those disclosed in Gibson and al. review (Gibson, V. C.; Spitzmesser, S. K., Chem. Rev. 2003, 103, p. 283). But there is still a need to improve either the specificities or the performances of these systems.

It is an aim of the present invention to prepare a polymerisation catalyst system based on monooxime ligands.

It is also an aim of the present invention to use monooxime ligand-based catalyst system for the homo- or co-polymerisation of ethylene and alpha-olefins.

Accordingly, the present invention discloses monooxime ligands of general formula I

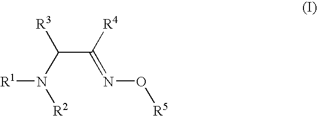

wherein R¹, R² R³, R⁴ and R⁵ are each independently selected from H or alkyl groups having from 1 to 20 carbon atoms or aryl groups having from 3 to 18 carbon atoms or functional groups such as heterocycles or two neighbouring Rⁱ can be linked together to form a ring.

The present invention also discloses a method for preparing monooxime ligands that comprises the steps of:

a) dissolving in a solvent a secondary amine of formula

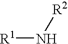

wherein R¹ and R² are as described here-above,

b) suspending in the same or another solvent an oxime precursor of formula

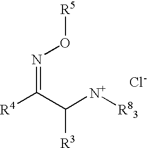

wherein R⁸ is an alkyl group and R³, R⁴ and R⁵ are as described above;

c) reacting the secondary amine with at least 1 equivalent of the oxime precursor;

d) separating the monooxime ligand from residual oxime precursor and salt by-product;

e) retrieving the monooxime ligand.

An oxime precursor TACO is described for example in Goldcamp et al. (M. J. Goldcamp, S. D. Edison, L. N. Squires, D. T. Rosa, N. K. Vowels, N. L. Coker, J. A. Krause Bauer, and M. J. Baldwin, in Inorg. Chem., 42, 717-728, 2003) or in Pavlishehuk et al. (V. V. Pavlishehuk, S. V. Kolotilov, A. W. Addison, M. J. Prushan, R. J. Butcher and L. K. Thompson, in Inorg. Chem. 38, 1759-1766, 1999).

The oxime precursor can be prepared according to the scheme

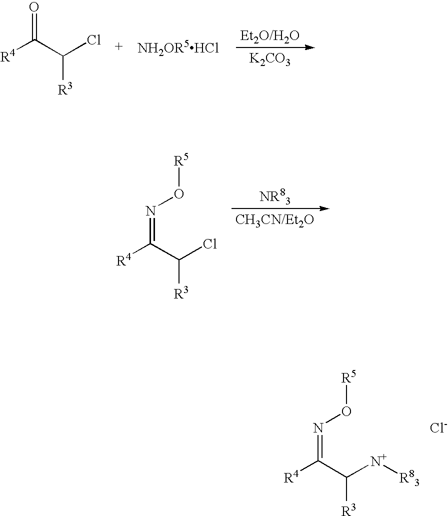

wherein preferably, R³ and R⁵ are the same and are hydrogen, R⁴ is methyl and R⁸ is ethyl: this preferred precursor is called TACO.

The secondary amine is obtained by reacting a primary amine R¹—NH₂ with an aldehyde R²—CHO followed by a treatment with a reducing agent, preferably with NaBH₄. The reaction temperature is selected according to the substituents' reactivity. Heating can be carried out either by conventional methods or with microwave energy.

Among the preferred embodiments according to the present invention, R¹ and R² can each be independently selected from isopropyl, n-butyl, benzyl, cyclohexyl, pyridine, thiophene, furane, phenyl, mesityl.

Preferably, both the secondary amine and the oxime precursor are suspended in the same solvent. The solvent is polar, preferably, it is acetonitrile.

The catalyst component is then prepared by complexing the ligand with a metallic precursor in a ratio from 1/1 to 2/1. The metallic precursor and the ligand are placed in a solvent and they are allowed to react under stirring for a period of time of from 2 to 10 hours at a temperature of from 10 to 80° C. preferably at room temperature (about 25° C.).

The metal is selected from groups 6 to 10 of the Periodic Table. Preferably, it is Cr, Fe, Co, Ni, Pd, more preferably it is nickel or chromium.

The solvent is polar or apolar. Preferably it is tetrahydrofuran (THF).

An active catalyst system is then prepared by adding an activating agent having an ionising action.

Any activating agent having an ionising action known in the art may be used for activating the monooxime catalyst component. For example, it can be selected from aluminium-containing or boron-containing compounds. The aluminium-containing compounds comprise aluminoxane and/or alkyl aluminium.

The aluminoxanes are preferred and may comprise oligomeric linear and/or cyclic alkyl aluminoxanes represented by the formula:

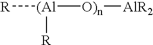

for oligomeric, linear aluminoxanes and

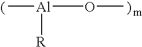

for oligomeric, cyclic aluminoxane,
wherein n is 1-40, preferably 10-20, m is 3-40, preferably 3-20 and R is a C₁—C₈ alkyl group and preferably methyl.

Suitable boron-containing activating agents that can be used comprise a triphenylcarbenium boronate such as tetrakis-pentafluorophenyl-borato-triphenylcarbenium as described in EP-A-0427696, or those of the general formula [L′−H]+[B Ar₁ Ar₂ X₃ X₄]—as described in EP-A-0277004 (page 6, line 30 to page 7, line 7).

The preferred activating agent is aluminoxane. The amount of aluminoxane necessary to activate the catalyst component is selected to have a Al/M ratio of from 100 to 3000.

The catalyst system can also be supported. The support if present can be a porous mineral oxide, advantageously selected from silica, alumina and mixtures thereof, modified by an activating agent. Preferably it is silica modified by MAO.

In this case, a cocatalyst may be added. The cocatalyst may be selected from triethylaluminium, triisobutylaluminum, tris-n-octylaluminium, tetraisobutyidialuminoxane, methylaluminoxane or diethyl zinc.

The present invention also discloses a method for oligomerising and for homo- or co-polymerising ethylene and alpha-olefins that comprises the steps of:

a) injecting the active catalyst system into the reactor;

b) injecting the monomer and optional comonomer into the reactor either before or after or simultaneously with step a);

c) maintaining under polymerising conditions;

d) retrieving the oligomers and polymers.

The polymerisation and oligomerisation method is not particularly limited and it can be carried out at a temperature of from 20 to 85° C. and under a pressure of from 0.5 to 50 bars.

The preferred monomers and comonomers are selected from ethylene, propylene and hexene.

### LIST OF FIGURES

FIG. 1 represents the structure of a nickel complex prepared from a furane-furane ligand.

FIG. 2 represents the structure of a nickel complex prepared from a furane-phenyl ligand.

### EXAMPLES

### Synthesis of the Ligand

a) Synthesis of the oxime precursor, TACO.

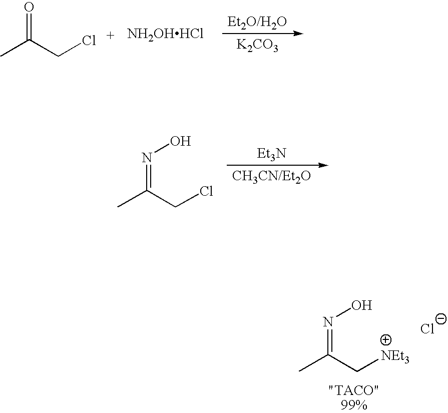

In a 250 mL flask, 3.82 g (55 mmol, 1.1 equ) of hydroxylamine hydrochloride were dissolved in 20 mL of water. A solution of 4.15 mL (50 mmol, 1 equ) of chloroacetone in 50 mL of ether was added to the flask. 3.8 g (27.5 mmol, 0.5 equ) of potassium carbonate were slowly added little by little, under stirring, at a temperature of 0° C. The biphasic mixture was brought back to room temperature (about 25° C.) and was stirred for a period of time of 2 hours.

The two phases were then separated and the aqueous phase was extracted with 15 mL of ether. The two ether phases were combined and 7.31 g (52 mmol, 1.04 equ) of triethylamine diluted in 15 mL of acetonitrile were added drop-wise, under stirring. It was kept under stirring for a period of time of 30 minutes and gave a white precipitate that was filtered out and washed with 30 mL of cold acetonitrile. After drying under vacuum, 10.31 g of solid (TACO) were obtained with a yield of 99%. The structure of TACO was confirmed by ¹H NMR analysis.

b) Synthesis of secondary amines.

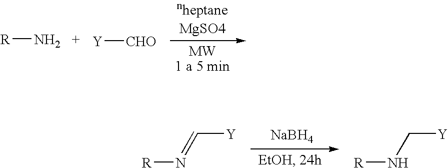

In a micro-wave cell, magnesium sulphate, 5 mL of ⁿheptane, 4 mmol of primary amine and 4 mmol of aldehyde were added. The mixture was heated in the micro-wave cell with a power of 100 to 300 W for 1 to 5 minutes. After cooling, the mixture was filtered, rinsed with ethyl acetate and the organic phases were assembled.

After evaporation under vacuum, 8 mL of absolute ethanol were added to the residue followed by the addition of sodium borohydride. The reaction mixture was stirred for a period of time of 24 hours at a temperature of 20 to 75° C. The solvent was then evaporated under vacuum and the residue was treated with 15 mL of ethyl acetate. The sodium borohydride was than hydrolysed with 10 mL of water and the aqueous phase was removed. The organic phase was dried on magnesium sulphate, filtered and evaporated under vacuum.

Several combinations of aldehydes and primary amines were used to prepare different secondary amines. For each example, the amount of sodium borohydride and the reaction temperature are displayed in Table I

TABLE I

| Aldéhyde | Amine I^{r} | NaBH₄ | T | Amine II^{r} | Yield |
|---|---|---|---|---|---|
| 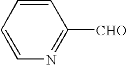 | 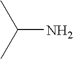 | 165 mg 1.1 éq | 20° C. | 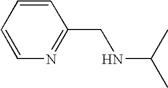 | >99% |
| 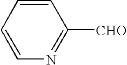 | 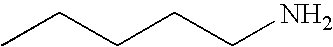 | | | 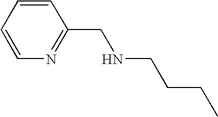 | >99% |
| 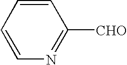 | 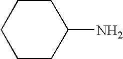 | | | 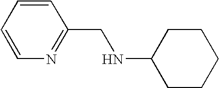 | >99% |
| 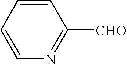 | 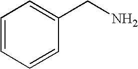 | | | 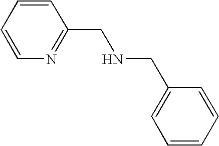 | 91% |
| 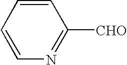 | 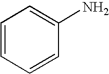 | | | 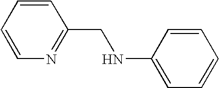 | >99% |
| 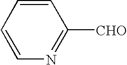 | 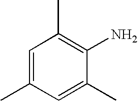 | 450 mg 3 éq. | 75° C. | 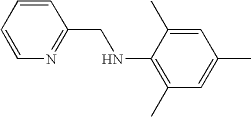 | 93% |
| 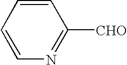 | 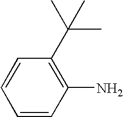 | | | 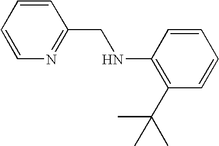 | 67% |
| 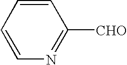 | 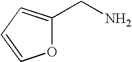 | | 20° C. | 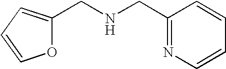 | 65% |
| 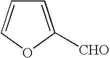 | 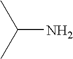 | 165 mg 1.1 éq. | 20° C. | 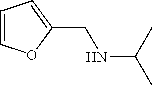 | 56% |
| 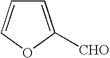 | 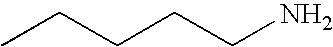 | | | 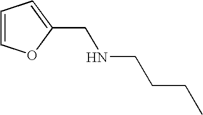 | 96% |
| 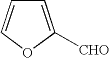 | 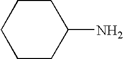 | 165 mg 1.1 éq. | 20° C. | 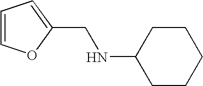 | >99% |
| 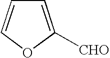 | 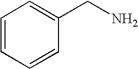 | | | 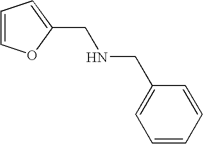 | >99% |
| 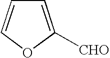 | 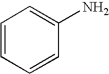 | | | 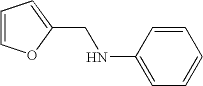 | >99% |
| 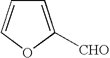 | 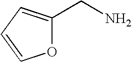 | 450 mg 3 éq. | | 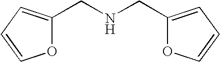 | >99% |
| 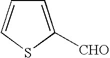 | 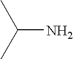 | 165 mg 1.1 éq. | 20° C. | 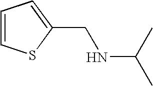 | >99% |
| 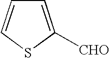 | 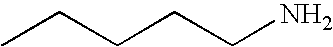 | | | 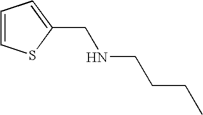 | >99% |
| 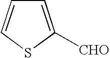 | 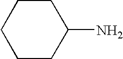 | | | 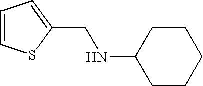 | 95% |
| 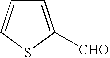 | 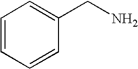 | | | 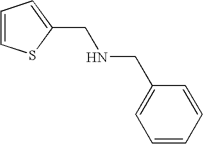 | >99% |
| 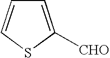 | 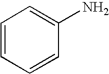 | | | 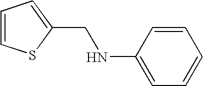 | >99% |
| 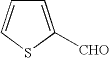 | 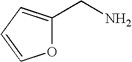 | 450 mg 3 éq. | | 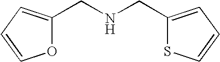 | >99% |

c) Synthesis of monooxime ligands.

All the secondary amines prepared in b) were then used to prepare ligands according to the following general scheme:

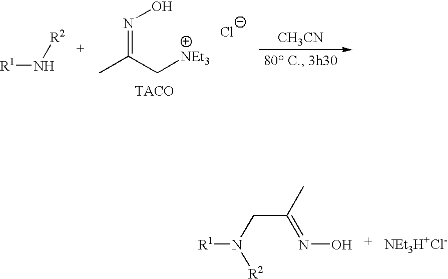

1.5 mmol (1 equ) of the secondary amine was dissolved in 20 mL of acetonitrile and 1.1 to 1.5 equivalents of TACO were added. The mixture was heated at a temperature of 80° C. for a period of time of 3 h 30. The solvent was vaporised and the residue was mixed with ethyl acetate. The mixture was then filtered to remove residual TACO and triethylamine salt and the filtrate was vaporised under vacuum.

The reaction conditions and resulting ligands are displayed in Table II

TABLE II

| Amine | Ligand | TACO | Yield |
|---|---|---|---|
| 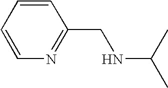 | 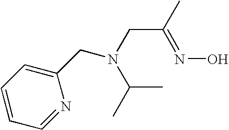 | 344 mg1.65 mmol 1.1 éq. | 87% |
| 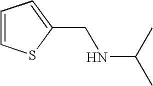 | 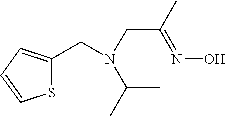 | | 92% |
| 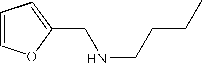 | 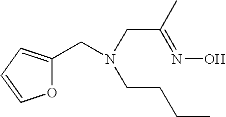 | | 96% |
| 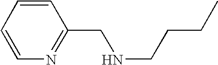 | 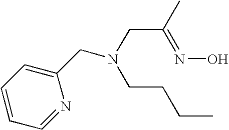 | | 92% |
| 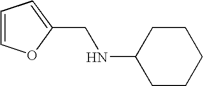 | 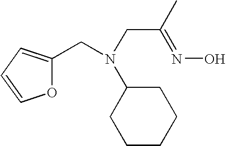 | | 99% |
| 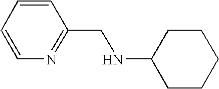 | 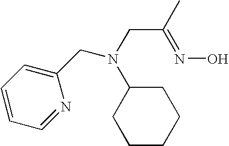 | | 41% |
| 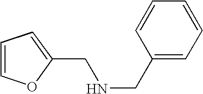 | 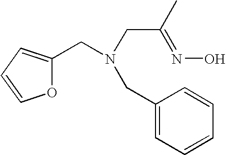 | | 99% |
| 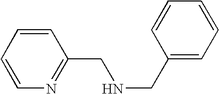 | 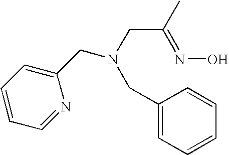 | | 92% |
| 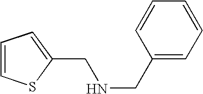 | 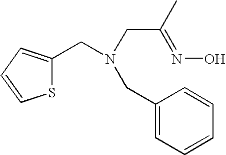 | 344 mg1.65 mmol 1.1 éq. | 99% |
| 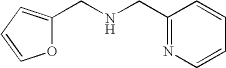 | 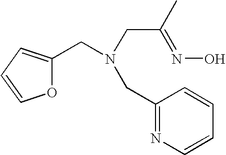 | | 91% |
| 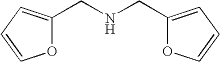 | 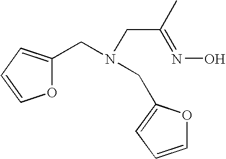 | | 98% |
| 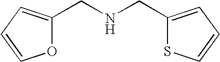 | 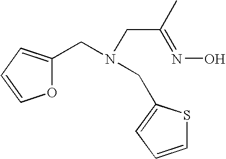 | | 97% |
| 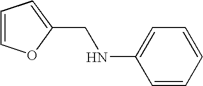 | 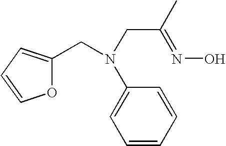 | 470 mg2.25 mmol 1.5 éq. | (*) |
| 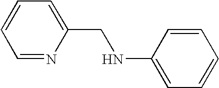 | 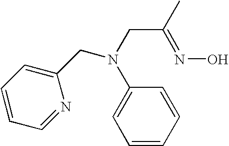 | | (*) |
| 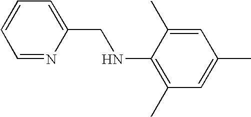 | 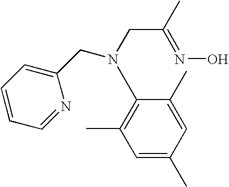 | | (*) |
| 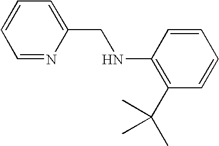 | 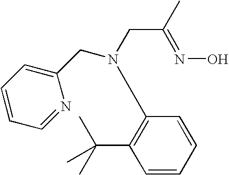 | | (*) |

(*) Contain residual amine.

Four ligands were particularly studied and characterised by NMR.

Ligand L1 (N-(pyridin-2-yl)methyl-N-benzyl-N-(1-propan-2-onyl oxime)amine)

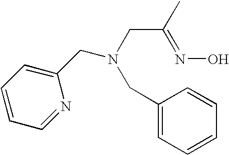

RMN ¹H (300 MHz, CDCl₃) δ: 9.14 (sl, 1H), 8.54-8.52 (m, 1H), 7.70 (td, J₁=1.9 Hz, J₂=7.9 Hz, 1H), 7.57 (d, J=7.9 Hz, 1H), 7.39-7.15 (m, 6H), 3.77 (s, 2H), 3.61 (s, 2H), 3.13 (s, 2H), 1.95 (s, 3H);

RMN ¹³C (75 MHz, CDCl₃) δ: 159.8, 156.3, 148.7, 138.9, 136.7, 128.9, 128.3, 127.1, 123.0, 122.1, 59.6, 58.5, 58.0, 12.4;

EIMS m/z [M]⁺ 269.1531, calcd for C₁₆H₁₉N₃O 269.1528; Anal. Calcd C, 71.35; H, 7.11; N, 15.60. Found: C, 70.63; H, 7.05; N, 16.33.

Ligand L2 (N-(furan-2-yl)methyl-N-benzyl-N-(1-propan-2-onyl oxime)amine)

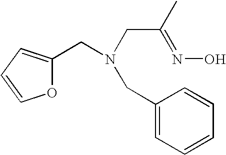

RMN ¹H (200 MHz, CDCl₃) δ: 8.25 (sl, 1H), 7.42-7.27 (m, 6H), 6.35 (dd, J₁=1.8 Hz, J₂=3.3 Hz, 1H), 6.23 (d, J=2.9 Hz, 1H), 3.64 (s, 2H), 3.61 (s, 2H), 3.15 (s, 2H), 1.96 (s, 3H); RMN ¹³C (75 MHz, CDCl₃) δ: 157.4,152.1, 142.1, 138.9, 129.0, 128.3, 127.1, 110.1, 109.0, 57.7, 57.3, 49.6, 12.4; EIMS m/z [M-OH]⁺241.1337, calcd for C₁₅H₁₇N₂O 241.1341; Anal. Calcd C, 69.74; H, 7.02; N, 10.84. Found: C, 69.85; H, 7.08; N, 10.81.

Ligand L3 (N,N-bis(furan-2-yl)methyl-N-(1-propan-2-onyl oxime)amine)

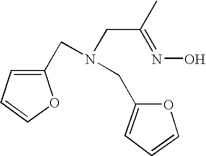

RMN ¹H (300 MHz, CDCl₃) δ: 9.09 (sl, 1H), 7.39 (dd, J₁=0.8 Hz, J₂=1.9 Hz, 1H), 6.33 (dd, J₁=1.9 Hz, J₂=3.0 Hz, 1H), 6.24 (d, J=3.0 Hz, 1H), 3.65 (s, 4H), 3.14 (s, 2H), 1.93 (s, 3H);

RMN ¹³C (75 MHz, CDCl₃) δ: 157.1, 151.9, 142.2, 110.1, 109.1, 56.9, 49.5, 12.3;

EIMS m/z [M]⁺ 248.1177, calcd for C₁₃H₁₆N₂O₃ 248.1161.

Ligand L4 (N-(furan-2-yl)methyl-N-phenyl-N-(1-propan-2-onyl oxime)amine)

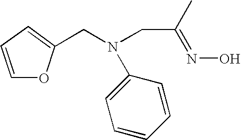

RMN ¹H (300 MHz, CDCl₃) δ: 8.44 (sl, 1H), 7.38 (dd, J₁=0.8 Hz, J₂=1.9 Hz, 1H), 7.25 (td, J₁=7.2 Hz, J₂=1.9 Hz, 1H), 6.91 (d, J=7.9 Hz, 1H), 6.79 (t, J=7.1 Hz, 1H), 6.32 (dd, J₁=1.9 Hz, J₂=3.4 Hz, 1H), 6.20 (dd, J₁=0.8 Hz, J₂=3.4 Hz, 1H), 4.49 (s, 2H), 4.07 (s, 2H), 1.87 (s, 3H);

RMN ¹³C (75 MHz, CDCl₃) δ: 156.4,151.9, 148.6, 142.0,129.2, 117.9, 113.6, 110.3, 107.8, 54.4, 48.0,11.6;

EIMS m/z [M]⁺244.1228, calcd for C₁₄H₁₆N₂O₂ 244.1212; Anal. Calcd C, 68.83; H, 6.60; N, 11.47. Found: C, 69.05; H, 6.79; N, 12.03.

### Polymerisation of Ethylene

Preparation of active catalyst system.

Ligands L1 to L4 were complexed with a metallic precursor.

### Nickel Complexes

They were complexed with metallic precursor Ni(DME)Br₂. In a glovebox, a solution of 25 μmol of ligand in 6 mL of tetrahydrofuran (THF) was added to a Schlenk, followed by a solution of 25 μmol of metallic precursor in 6 mL of THF. The complexation reaction was carried out for a period of time of 4 h under stirring. THF was then removed under vacuum for a period of time of 3 h.

The resulting complexes crystallised as dimers containing two units of monomeric complex linked by bromine bridges. For ligand L2, on each unit, nickel was coordinated to the ligand through the central nitrogen atom, that of the oxime function and oxygen in one of the furane groups. The complex had bi-pyramidal geometry. For ligand L4, nickel was coordinated to the ligand through the central nitrogen atom and that of the oxime function.

The catalyst component was then activated with 1000 equivalents of methylaluminoxane (MAO). 4 mL of a 30 wt. % solution of MAO in toluene (730 equ) were added to the untreated complexation product and the mixture was kept under stirring for 5 to 10 minutes. In the reactor under inert atmosphere 50 mL of toluene were added followed by the addition of a scavenger solution prepared from 1.5 mL of a 30 wt. % solution of MAO in toluene (270 equ) and 3.5 mL of toluene, followed by the addition of the activated complex diluted in 1 mL of toluene. The temperature was raised to 35° C. and the polymerisation of ethylene was carried out at a temperature of 35° C. and under an ethylene pressure of 15 bar, for a period of time of about 2 h.

Oligomers and polymers of ethylene were recovered after degassing. The polymers were washed with a 5% MeOH/HCl, then with MeOH and finally with acetone. They were then dried under vacuum overnight.

The results are summarised in Table III.

TABLE III

| | Amount | Colour | Colour | Mass | Polymerisation | C2 | | |
|---|---|---|---|---|---|---|---|---|
| | complex | before | after | PE | time | consumed | Activity | Tₘ^{(b)} |
| Catalyst | (μmol) | activation | activation | (g) | (min) | (kg/h · mol)^{(a)} | (kgPE/h · mol) | (° C.) |
| Ni(DME)Br₂ + L1 | 25 | Pale | orange | 0.14 | 126 | 99 | 2.7 | 124 |
| | | green | | | | | | |
| Ni(DME)Br₂ + L2 | 25 | Yellow- | dark | 0.15 | 129 | 896^{(c)} | 2.8 | 112 |
| | | green | brown | | | | | |
| Ni(DME)Br₂ + L2 | 5 | | | 0.24 | 128 | 1185 | 22.5 | 120 |
| Ni(DME)Br₂ + L3 | 25 | Yellow- | Dark | 0.37 | 126 | 722 | 7.0 | 112 |
| | | green | Brown | | | | | |
| Ni(DME)Br₂ + L4 | 25 | Green | black | 1.17 | 128 | 489 | 21.8 | 110 |
| | | (pink in | | | | | | |
| | | THF) | | | | | | |

^{(a)}measured after 1 h
^{(b)}Melting point measured by Differential Scanning Calorimetry (DSC) method
^{(c)}Full reactor

These results show that ligands L2, L3 and L4 carrying a furane group lead to efficient catalysts systems.

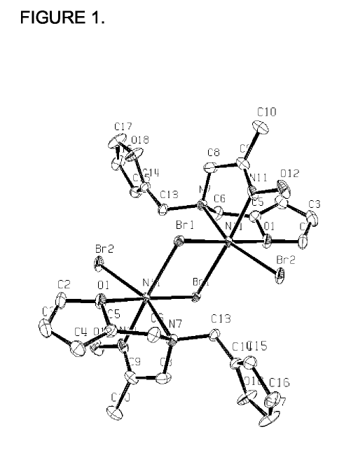

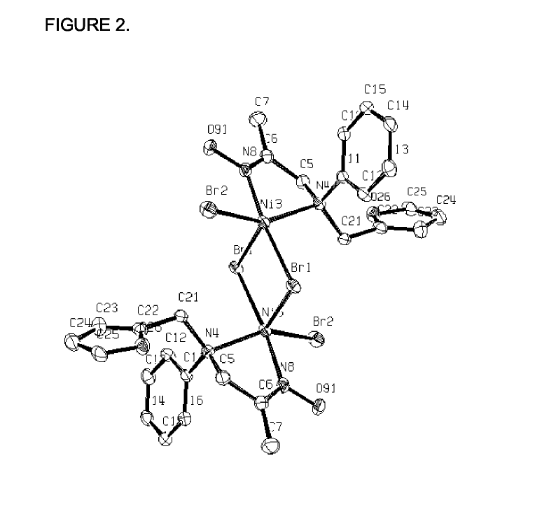

The structure of the complexes prepared from ligands L2 and L4 are represented respectively in FIGS. 1 and 2.

It can be seen in FIG. 1 that in the case of a furane-furane ligand, nickel coordinates the 2 nitrogen atoms and the oxygen atom of one of the two furanes. FIG. 2 shows that for a furane-phenyl ligand, only the nitrogen atoms are coordinated by nickel.

The concentration of metallic precursor and ligand in the solvent for the complexation step has also been studied for L2 ligand complexed with Ni(DME)Br2. The complexation reaction was carried out using 1 equivalent of ligand per atom of metal in THF for a period of time of 4 h 30. It was then dried under vacuum for 3 h. The complex was activated with 1000 equivalents of MAO and the polymerisation was carried out in toluene at a temperature of 35° C., under an ethylene pressure of 15 bars and for a period of time of 2 hours. The concentration of metallic complex for the complexation step was varied as indicated in table IV and the polymerisation results are reported in the same table.

TABLE IV

| Concentration for | | |
|---|---|---|
| complexation step | C2 consumption^{(a)} | Activity |
| μmol/mL | Kg C2/mol Ni/h | Kg PE/mol Ni/h |
| 2.1 | 1185 | 22.5 |
| 8.3 | 1103 | 60.6 |

^{(a)}Quantity of complex for polymerisation = 10 μmol

It must be noted that the amount of Ni present in the reactor was the same for both polymerisations, but the complexes were prepared using different complex concentrations in the solvent and the increase in concentration of complexation leads to an increase of the polymerisation activity.

The polymerisation of ethylene was carried out under different conditions of temperature, ethylene pressure and presence of support.

Ligand L2 complexed with nickel was used to determine the influence of temperature. The results are summarised in Table V.

TABLE V

| | | |
|---|---|---|
| Temperature (° C.) | 35 | 60 |
| Ethylene consumption | 1.2 | 0.56 |
| (tC₂H₄/molNi/h) | | |
| Uncomplexed metal | Very little | Important |
| Consumption profile | Activity reduced | Activity reduced |
| | after 40 min | after 30 min |

At a pressure of 15 bars, it was thus observed that the activity at a temperature of 60° C. was about half that obtained at a temperature of 35° C. In addition, metal was found in large quantity as a black residue at the end of the reaction and the consumption curve showed a rapid deactivation, indicative of reduced stability of the system. The oligomers were identified by gas chromatography as represented in Table VI.

This analysis is performed on a Varian 3900 apparatus with a DB-Petro capillary column (methyl silicone, 100 m long, i.d. 0.25 mm, film thickness 0.5 μm) working at a temperature of 35° C. for 15 min, heating at 5° C. min⁻¹ until 250° C., and staying at a temperature of 250° C. for 15 min (flow rate=1 mL.min⁻¹).

TABLE VI

| T (° C.) | C₄ | alpha-C₄ | C₆ | alpha-C₆ | C₈ |
|---|---|---|---|---|---|
| 35 | 44% | 43% | 41% | 14% | 15% |
| 60 | 75% | 48% | 17% | 15% | 9% |

The amount of C₄ was observed to increase with increasing temperature.

The ethylene pressure results, carried out on the same catalyst system, are reported in Table VII.

TABLE VII

| | | |
|---|---|---|
| Pressure (bars) | 15 | 22 |
| Ethylene consumption | 1.2 | 1.93 |
| (tC₂H₄/molNi/h) | | |
| Uncomplexed metal | Important | Negligeable |
| Consumption profile | Activity reduced | Constant |
| | after 40 min | |

At a temperature of 35° C., the activity and stability of the catalyst system increased with increasing ethylene pressure.

Ligands L2 and L4 were complexed with nickel and deposited on a silica support activated with methylaluminoxane (MAO). The solvent was toluene and the scavenger was 0.2 mL of 30% MAO in toluene. The results are reported in Table VIII.

TABLE VIII

| | Mass supp. | Amount | | | |
|---|---|---|---|---|---|
| | catalyst | catalyst | T | P | Consumption |
| Ligand | (mg) | (μmol) | (° C.) | (bars) | (tC₂H₄/molNi/h) |
| L2 | 196 | 9.7 | 35 | 15 | 0.27 |
| L2 | 212 | 10.5 | 60 | 22 | 0.2 |
| L4 | 195 | 9.7 | 35 | 15 | 0.23 |

The activity was smaller than in homogeneous polymerization. The distribution of oligomers obtained by gas chromatography is displayed in Table IX.

TABLE IX

| | | |
|---|---|---|
| C₄ % | C₆ % | C₈ % |

| Ligand | Total | α | Total | α | Total |
|---|---|---|---|---|---|
| L2 | 83 | 68 | 6 | 26 | 11 |
| L2 | 66 | 76 | 15 | 32 | 16 |
| L3 | 71 | 81 | 16 | 39 | 25 |

The amount of C₄ produced in supported polymerisation was of at least 80%.

### Chromium Complexes

Ligands L1 to L4 were also reacted with CrCl₂ in order to form chromium complexes. These complexes were activated and used in the polymerisation of ethylene.

In the complexation reaction the following conditions were used:

Metal/ligand ratio=1/1

Solvent=THF

Amount of each element=20 μmol

Concentration for each element=6.7 μmol/mL

Reaction time=4 h

Drying time=2 h 30 under vacuum.

For the polymerisation of ethylene the following conditions were used:

Activation with 1000 equivalents of MAO

Solvent=toluene

Temperature=35° C.

Pressure=15 bars

Polymerisation time=1 h

In homogeneous polymerisation, the activities expressed in kgPE/molCr/h were as follows:

Ligand L1: 18

Ligand L2: 26

Ligand L3: 93

Ligand L4: 19

The results show that furane group is more favourable than pyridine group.

The influence of temperature on the polymerisation carried out at a pressure of 15 bars with ligand L3 is summarised in Table X.

TABLE X

| | | | |
|---|---|---|---|
| Temperature (° C.) | 35 | 55 | 80 |
| Mass PE (g) | 1.86 | 0.62 | 0.19 |
| Activity | 93 | 31 | 10 |
| (KgPE/molCr/h) | | | |
| Tm (° C.) | 129.3 | 125.7 | 131.1 |
| Appearance | Fine powder | Rough powder | Chips |

The activity of the catalyst system and the morphology of the resulting polymers were strongly influenced by the temperature, the activity decreasing with increasing temperature.

The influence of ethylene pressure at a polymerisation temperature of 35° C. is summarised in table XI.

TABLE XI

| | | |
|---|---|---|
| Pressure (bars) | 15 | 24 |
| Mass PE (g) | 1.86 | 2.23 |
| Activity | 93 | 115 |
| (KgPE/molCr/h) | | |
| Tm (° C.) | 128.9 | 130.3 |

The activity was not significantly improved with a substantial increase in ethylene pressure.

The chromium complexes prepared from ligands L1 to L3 were supported on silica/MAO and used in the polymerization of ethylene. Ethylene polymerisation reactions were carried out in a 130 ml stainless steel autoclave equipped with mechanical stirring and a stainless steel injection cylinder. In a typical reaction run, the reactor was first dried under nitrogen flow at 100° C. during 10 min. Then it was cooled down to the reaction temperature (50° C.) and 35 ml of isobutane were introduced into the reactor with a syringe pump, followed by the comonomer if required. The pressure was adjusted to the desired value (23.8 bar) with ethylene. In an argon-filled glove box, about 255 mg of the supported catalyst (complex deposited on MAO impregnated silica, at 2 wt % based on the total weight of the supported catalyst), the cocatalyst and 0.6 ml of n-hexane were placed into the injection cylinder. The valve was closed and the cylinder was connected to the reactor under nitrogen flow. The active catalyst mixture was then introduced into the reactor with 40 ml of isobutane. After 30 minutes or 1 hour, the reactor was cooled down to room temperature and slowly depressurised, and the polymer was recovered. The results are displayed in Table XII.

TABLE XII

| | Mass | | | | |
|---|---|---|---|---|---|
| | supp. | Cr content on | | Activity | |
| | cata. | support | Amount Cr | (KgPE/ | Tm |
| Ligand | (mg) | (μmolCr/gsupp.) | (μmol) | molCr/h) | (° C.) |
| L1 | 254.6 | 44.21 | 11.3 | 85.3 | 131.0 |
| L2 | 255.9 | 38.46 | 9.8 | 104.7 | 131.6 |
| L3 | 252.6 | 55.77 | 14.1 | 227.1 | 132.1 |

The results show the excellent performances of ligand L3 in supported catalysis.

In order to obtain valid comparisons between homogeneous and supported polymerization, ligand L3 was used in both homogeneous and supported polymerisation using 20 μmol of Cr and a polymerization time of 1 hour. The temperature and pressure conditions and results are displayed in Table XIII.

TABLE XIII

| | Activity homogeneous | Activity supported |
|---|---|---|
| T (° C.)/P (bars) | (KgPE/molCr/h) | (KgPE/molCr/h) |
| 35-40/15 | 93 | 139.2 |
| 50/24 | 123 | 227.1 |

Simultaneous increase in temperature and pressure had a very positive influence on activity in both supported and homogeneous polymerisation of ethylene for ligand L3, at elevated pressure. At low pressure, an increase in temperature had a negative influence on activity. The system is thus thermally more resistant at elevated pressure.

### Polymerisation of Hexene

Ligand L2 was tested in the polymerisation of hexene. In a glove box, a solution of 10 μmol of ligand L2 in 2.5 mL of THF was added to a Schlenk, followed by a solution of 10 μmol of metallic precursor Ni(DME)Br₂ in 2.5 mL of THF. The complexation reaction was carried out for a period of time of 4 h under stirring. 0.25 mL of that solution, corresponding to 0.5 μmol of each element, was taken and placed in a Schlenk under argon. THF was then removed under vacuum for a period of time of 3 h.

The catalyst component was then activated with 2200 equivalents of methylaluminoxane (MAO). 220 μL of a 30 wt. % solution of MAO in toluene were vaporised. The residue was dissolved in 2.5 mL of 1-hexene and the monomer/activator solution was added under stirring to the untreated complexation product. The polymerisation of 1-hexene was carried out at room temperature for a period of time of about 1 h. The polymerisation was ended by adding a 5% MeOH/HCl and the solution was extracted with ⁿheptane. The polymer is retrieved after evaporation of ⁿheptane and drying under vacuum at a temperature of 50° C. during 24 h. 97 mg of polymer were obtained, corresponding to an activity in polyhexene of 194 kg/mol Ni/h.

1-8. (canceled)

9. An active catalyst system comprising:
a metallic complex prepared by complexation of a metallic precursor selected from Groups 6 to 10 of the Periodic Table and a monooxime ligand of general formula I: 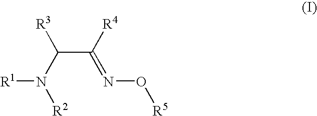
wherein R¹, R², R³, R⁴ and R⁵ are each independently selected from H, C₁ to C₂₀ alkyls, C₃ to C₁₈ aryls, functional groups or two neighboring R are linked together to form a ring; and
an activating agent having adapted to ionize the metallic complex.

10. The active catalyst system of claim 9, wherein R¹, R², R₃, R⁴ and R⁵ are each independently selected from hydrogen, methyl, isopropyl, n-butyl, benzyl, cyclohexyl, pyridine, thiophene, furane, phenyl, mesityl and combinations thereof.

11. The active catalyst system of claim 10, wherein at least one of R¹, R², R³, R⁴ and R⁵ is a heterocyclic complex.

12. The active catalyst system of claim 9, wherein the activating agent is selected from aluminoxane or silica modified by aluminoxane.

13. A method for preparing an active catalyst system comprising:
dissolving a secondary amine represented by the formula: 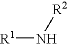
wherein R¹ and R² are each independently selected from H, C₁ to C₂₀ alkyls, C₃ to C₁₈ aryls, functional groups or two neighboring R are linked together to form a ring;
suspending an oxime precursor represented by the formula: 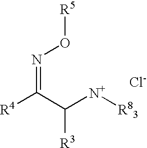
wherein R³, R⁴ and R⁵ are each independently selected from H, C₁ to C₂₀ alkyls, C₃ to C₁₈ aryls, functional groups or two neighboring R are linked together to form a ring and R⁸ is an alkyl group;
reacting the secondary amine with at least 1 equivalent of the oxime precursor to form a monooxime ligand;
separating the monooxime ligand from residual oxime precursor and salt by-product;
complexing the monooxime ligand and a metallic precursor to form a metallic complex; and
activating the metallic complex with an activating agent adapted to ionize the metallic complex.

14. The method of claim 13, wherein the metallic precursor comprises Ni, Cr, Co, Fe or Pd.

15. A method for polymerizing olefins comprising:
introducing an active catalyst system into a reactor, wherein the active catalyst system comprises:
a metallic complex prepared by complexation of a metallic precursor selected from Groups 6 to 10 of the Periodic Table and a monooxime ligand of general formula I: 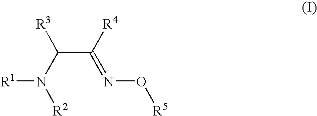
wherein R¹, R², R³, R⁴ and R⁵ are each independently selected from H, C₁ to C₂₀ alkyls, C₃ to C₈ aryls, functional groups or two neighboring R are linked together to form a ring; and
an activating agent having adapted to ionize the metallic complex;
introducing an olefin monomer into the reactor;
contacting the olefin monomer with the active catalyst system to form polyolefin; and
recovering the polyolefin from the reactor.

16. The method of claim 15, wherein the olefin is propylene or 1-hexene.
